(19) United States
(12) Patent Application Publication
(10) Pub. No.: US 2011/0077874 A1
(43) Pub. Date: Mar. 31, 2011

(54) APPLIANCE MONITORING APPARATUS

(75) Inventors: Tsuyoshi Honda, Osaka (JP); Hiroshi Takechi, Osaka (JP); Kouji Murase, Osaka (JP); Kenji Yasuda, Osaka (JP); Mitsuo Namba, Tokyo (JP); Kazuo Kubo, Osaka (JP); Hisashi Saito, Tokyo (JP)

(73) Assignees: Panasonic Corporation, Kadoma-shi, Osaka (JP); The High Pressure Gas Safety Institute of Japan, Machida-shi, Tokyo (JP)

(21) Appl. No.: 12/993,667

(22) PCT Filed: Feb. 27, 2009
(86) PCT No.: PCT/JP2009/000876

§ 371 Date: Nov. 19, 2010

(30) Foreign Application Priority Data
May 20, 2008 (JP) 2008-132129

(51) Int. Cl. G06F 19/00

(52) U.S. Cl. 702/45

(57) ABSTRACT

A conventional appliance monitoring apparatus handles only the amount of gas used and security information for the case of a gas cutoff and can not address social needs for a desire to obtain information about influence (e.g., an amount of CO₂ emission) of use of the gas combustion appliance on a terrestrial environment.

A CO₂ emission calculation unit 4 calculates an amount of CO₂ emission based on a gas appliance used by a client output from an appliance determination unit 2, a gas flow signal thereof, and CO₂ emission data pertaining to the gas appliance stored in a CO₂ emission data storage unit 3. Thus, it is possible to determine the amount of CO₂ emission produced by using the gas appliance by the client.

### TECHNICAL FIELD

The present invention relates to an appliance monitoring apparatus for computing and determining the amount of CO₂ emissions, etc., generated during combustion by a gas combustion appliance, etc., that utilizes, for example, town gas, LP gas, etc.

### BACKGROUND ART

Conventionally, an appliance monitoring apparatus of this type monitors security information such as an amount of gas consumed by a gas combustion appliance and grounds for a cutoff when a gas is shut off (see, for example, Patent Document 1).

Patent Document 1: JP-A-2001-236116

### DISCLOSURE OF THE INVENTION

### Problem to be Solved by the Invention

However, the conventional appliance monitoring apparatus merely handles the amount of gas used and security information for the case of a gas cutoff, and does not take into account the influence (e.g., an amount of CO₂ emission) of use of a gas combustion appliance on a terrestrial environment. The appliance monitoring apparatus cannot address social needs for a desire to know the foregoing information against a backdrop of a growing concern about the terrestrial environment.

### MEANS FOR SOLVING THE PROBLEM

In order to solve the problem, a safety apparatus of the present invention detects a gas flow by use of a flow detection unit disposed in a gas flow path in a gas meter. Based on the signal, an appliance determination unit determines a gas appliance used by a client by learning a flow value, a gas consumption time, etc., and outputs information about the determined gas appliance and the gas flow signal used by the gas appliance to a subsequent stage.

A CO₂ emission data storage unit previously stores an amount of CO₂ emission produced during combustion for each type of the gas appliance as database.

A CO₂ emission calculation unit computes, integrates, and stores an amount of CO₂ emission based on the CO₂ emission data pertaining to a gas appliance selected from the CO₂ emission data storage unit on receipt of a signal from the appliance determination unit, a gas flow of the selected gas appliance, and a gas consumption time of the selected gas appliance. Accordingly, an amount of CO₂ emission produced by using the gas appliance being by the client can be determined. Hence, it becomes possible to address social needs for a desire to ascertain foregoing information against a backdrop of a growing concern about the terrestrial environment.

### ADVANTAGES OF THE INVENTION

The appliance monitoring apparatus of the present invention can determine an amount of CO₂ emission produced by using a gas appliance by the client. Hence, it becomes possible to address social needs for a desire to know the foregoing information against a backdrop of a growing concern about the terrestrial environment.

### BRIEF DESCRIPTION OF THE DRAWINGS

FIG. 1 is a control block diagram of an appliance monitoring apparatus of a first embodiment of the present invention.

### DESCRIPTION OF REFERENCE SIGNS

1 FLOW DETECTION UNIT
2 APPLIANCE DETERMINATION UNIT
3 CO₂ EMISSION DATA STORAGE UNIT
4 CO₂ EMISSION CALCULATION UNIT
5 TIMER UNIT
6 DISPLAY UNIT

### BEST MODE FOR CARRYING OUT THE INVENTION

A first invention provides: a flow detection unit disposed in a gas flow path in a gas meter and configured to detect a gas flow; an appliance determination unit configured to determine a gas appliance used by a client by leaning a flow value used by the client and a gas consumption time in accordance with a signal from the gas flow detection unit, and to output a gas flow signal used by the gas appliance; a CO₂ emission data storage unit configured to store an amount of a CO₂ emission previously determined for each type of the gas appliance as database; and a CO₂ emission calculation unit configured to compute, integrate, and store an amount of CO₂ emission based on the CO₂ emission data pertaining to a gas appliance selected from the CO₂ emission data storage unit on receipt of a signal from the appliance determination unit, a gas flow of the selected gas appliance, and a gas consumption time of the selected gas appliance. Accordingly, the amount of CO₂ emission produced by using the gas appliance by the client can be determined. Hence, it becomes possible to address social needs for a desire to know the foregoing information against a backdrop of a growing concern about the terrestrial environment.

In a second invention, the CO₂ emission data storage unit is configured such that the database of CO₂ emission previously stored for each type of gas appliance is changeable from an outside. Accordingly, it is possible to address an addition to the database regarding an amount of CO₂ emission for a new type of a gas appliance which has never been before, a change in the database of CO₂ emission caused by an improvement to the appliance, etc. Consequently, an amount of CO₂ emission produced by using the gas appliance by the user can be determined from the updated CO₂ emission database. Therefore, a more accurate amount of CO₂ emission can be determined.

In a third invention, when the integrated and stored amount of CO₂ emission has exceeded a value of a preset amount of CO₂ emission, the CO₂ emission calculation unit outputs that effect to an outside. Accordingly, it is possible to determine that the amount of CO₂ emission has exceeded a given value (e.g., a value of standard determined in consideration of influence on an environment) and to send a notification, which can clarify whether the amount of CO₂ emission produced by the client is large. Based on the information, when an appliance producing a large amount of CO₂ emission is used, replacement purchase of the appliance can be promoted, and when the amount of gas consumed by the client is large, self-restraint in a frequency of use of the gas appliance and an operating time of the gas appliance can be induced. Consequently, the amount of CO₂ emission produced by use of the gas appliance can be reduced.

In a fourth invention, every time the integrated and stored amount of CO₂ emission has exceeded a plurality of values of preset amounts of CO₂ emissions, the CO₂ emission calculation unit outputs that effect to an outside. When a plurality of values preset amounts of CO₂ emissions are set in sequence from a small given value of CO₂ emission to a given value of CO₂ emission (e.g., a value of standard determined in consideration of influence on an environment) as the maximum value, an increase in the amounts of CO₂ emissions can be consecutively reported. Accordingly, it is possible to clarify, in stages, an increase in the amount of CO₂ emission produced by the client. Consequently, when an appliance producing a large amount of CO₂ emission is used, it becomes much easier to promote replacement purchase of the appliance, and when the amount of gas consumed by the client is large, it becomes much easier to appeal for self-restraint in a frequency of use of the gas appliance and an operating time of the gas appliance. Therefore, the amount of CO₂ emission by use of the gas appliance can be reduced. When a plurality of values of the amounts of CO₂ emissions are set to values in excess of the given value (e.g., a value of standard determined in consideration of influence on an environment), an alarm about considerably large amounts of CO₂ emissions can also be issued to the outside, or use of gas appliances can be prohibited by cutting off a gas. Accordingly, when an appliance producing a large amount of CO₂ emission is used, replacement purchase of the appliance can be promoted, and when the amount of gas consumed by the client is large, an appeal for self-restraint on a frequency of use of the gas appliance and an operating time of the gas appliance can further be promoted.

In a fifth invention, information about the integrated and stored amount of CO₂ emission is displayed, which can indicate an amount of CO₂ emission at the time of watching the display. As a result, it is possible to readily confirm the amount of CO₂ emission produced by the client. Consequently, when an appliance producing a large amount of CO₂ emission is used, it becomes much easier to promote replacement purchase of the appliance, and when the amount of gas consumed by the client is large, it becomes much easier to appeal for self-restraint on a frequency of use of the gas appliance and an operating time of the gas appliance.

In a sixth invention, information about the integrated and stored amount of CO₂ emission is output to an outside. By obtaining the information, the integrated and stored amount of CO₂ emission can be confirmed in real time. Further, by providing a gas billing statement, etc., with the information, when an appliance producing a large amount of CO₂ emission is used, it becomes much easier to promote replacement purchase of the appliance, and when the amount of gas consumed by the client is large, it becomes much easier to appeal for self-restraint on a frequency of use of the gas appliance and an operating time of the gas appliance.

Embodiments of the present invention are described below with reference to the drawings. However, the present invention shall not be limited to the embodiments. Although CO₂ generated by combusting operation of a gas appliance is described in the embodiments of the invention, the present invention may embodied as an appliance monitoring apparatus for CO, NOₓ, SOₓ, etc., which is not limited to CO₂.

### FIRST EMBODIMENT

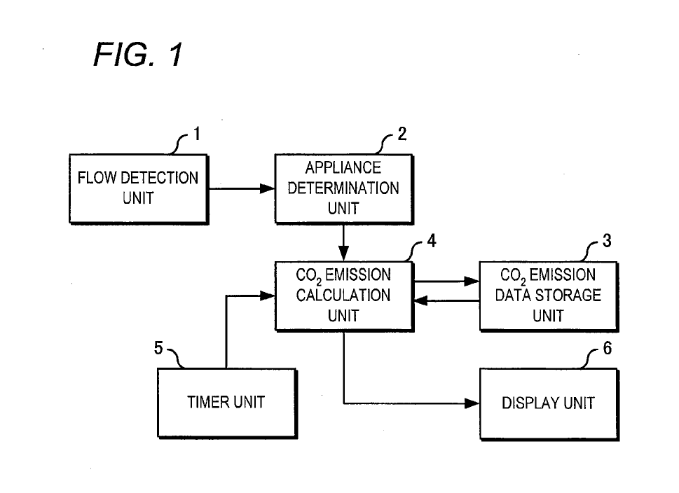

FIG. 1 is a control block diagram of an appliance monitoring apparatus of a first embodiment of the present invention.

In FIG. 1, reference numeral 1 designates a flow detection unit disposed in a gas flow path in a gas meter. Reference numeral 2 designates an appliance determination unit configured to determine a gas appliance used by a client. Reference numeral 3 designates a CO₂ emission data storage unit configured to store, as a database, an amount of CO₂ emission previously determined for each type of gas appliance. Reference numeral 4 designates a CO₂ emission calculation unit configured to compute, integrate, and store an amount of CO₂ emission based on the data pertaining to an amount of CO₂ emission of a gas appliance selected from the CO₂ emission data storage unit, a gas flow of the gas appliance, and a gas consumption time. Reference numeral 5 designates a timer unit configured to output a signal to the CO₂ emission calculation unit 4 every predetermined, given periods. The CO₂ emission calculation unit 4 is provided so as to display CO₂ emission data on the display unit 6 on receipt of the signal.

Operations and effects of the appliance monitoring apparatus are now described. The flow detection unit 1 is disposed in a gas flow path (not shown in the drawing) of the gas meter and detects the amount of gas flow. In accordance with a gas flow signal, the appliance determination unit 2 learns a flow value and a gas consumption time, thereby determining a gas appliance used by a client and outputting the gas flow signal used by the gas appliance. The CO₂ emission data storage unit 3 stores, as database, an amount of CO₂ emissions previously determined based on each type of the gas appliance. The CO₂ emission calculation unit 4 computes, integrates, and stores an amount of CO₂ emission based on the CO₂ emission data pertaining to a gas appliance selected from the CO₂ emission data storage unit 3 on receipt of the signal from the appliance determination unit 2, a gas flow of the selected gas appliance, and a gas consumption time of the selected gas appliance. The timer unit 5 outputs a signal to the CO₂ emission calculation unit 4 every predetermined, given periods (e.g., one month, a time period during which a gas charge is collected, etc.). On receipt of the signal, the CO₂ emission calculation unit 4 displays the CO₂ emission data on the display unit 6. Accordingly, an amount of CO₂ emission produced by using the gas appliance by the client can be determined. Hence, it is possible to address social needs for a desire to know foregoing information against a backdrop of a growing concern about the terrestrial environment.

The CO₂ emission data storage unit 3 may be configured such that the database of CO₂ emission previously stored for each type of gas appliance. Accordingly, it is possible to address an addition to the database regarding an amount of CO₂ emission for a new type of a gas appliance which has never been before, and a change in the database of CO₂ emission caused by an improvement to the appliance, etc. Consequently, an amount of CO₂ emission produced by using the gas appliance by the user can by determined from the updated CO₂ emission database. Therefore, a more accurate amount of CO₂ emission can be determined.

When the integrated and stored amount of CO₂ emission has exceeded a value of a preset amount of CO₂ emission, the CO₂ emission calculation unit 4 may output that effect to an outside. Accordingly, it is possible to determine that the amount of CO₂ emission has exceeded a given value (e.g., a value of standard determined in consideration of influence on an environment) and to send a notification, which can clarify whether the amount of CO₂ emission produced by the client is large. Based on the information, when an appliance producing a large amount of CO₂ emission is used, replacement purchase of the appliance can be promoted, and whwen the amount of gas consumed by the client is large, self-restraint in on a frequency of use of the gas appliance and an operating time of the gas appliance can be induced. Consequently, the amount of CO₂ emission produced by use of the gas appliance can be reduced.

Every time the integrated and stored amount of CO₂ emission has exceeded a plurality of values of preset amounts of CO₂ emissions, the CO₂ emission calculation unit 4 may output a signal that effect to the outside. When a plurality of preset values of CO₂ emissions are set in sequence from a given small value of CO₂ emission to a given value of CO₂ emission (e.g., a value of standard determined in consideration of influence on an environment) as the maximum value, an increase in the amounts of CO₂ emissions can be consecutively reported.

Accordingly, it is possible to clarify, in stages, an increase in the amount of CO₂ emission produced by the client. Consequently, when an appliance producing a large amount of CO₂ emission is used, it becomes much easier to promote replacement purchase of the appliance, and when the amount of gas consumed by the client is large, it becomes much easier to appeal for self-restraint in a frequency of use of the gas appliance and an operating time of the gas appliance. Therefore, the amount of CO₂ emission by use of the gas appliance can be reduced. When a plurality of values of the amounts of CO₂ emissions are set to values in excess of the given value (e.g., a value of standard determined in consideration of influence on an environment), an alarm about considerably large amounts of CO₂ emissions can also be issued to the outside, or use of gas appliances can be prohibited by cutting off a gas. Accordingly, when an appliance producing a large amount of CO₂ emission is used, replacement purchase of the appliance can be promoted, and when the amount of gas consumed by the client is large, self-restraint on a frequency of use of the gas appliance and an operating time of the gas appliance can further be promoted.

Information about an integrated and stored amount of CO₂ emission may be displayed. Accordingly, on watching the display unit 6, a person associated with the gas appliance (e.g., a gas appliance retail dealer, a common user, etc.) can know an amount of CO₂ emission at the time of watching the display. Consequently, when an appliance producing a large amount of CO₂ emission is used, it becomes much easier to promote replacement purchase of the appliance, and when the amount of gas consumed by the client is large, it becomes much easier to appeal for self-restraint on a frequency of use of the gas appliance and an operating time of the gas appliance.

Information about the integrated and stored amount of CO₂ emission may be output to the outside. By obtaining the information in this way, the integrated and stored amount of CO₂ emission can be confirmed in real time. Further, by providing a gas billing statement, etc., with the information, when an appliance producing a large amount of CO₂ emission is used, it becomes much easier to promote replacement purchase of the appliance, and when the amount of gas consumed by the client is large, it becomes much easier to appeal for self-restraint on a frequency of use of the gas appliance and an operating time of the gas appliance. Further, information may be reported to the outside of a gas cutoff apparatus, such as an alarm system (not shown) of a gas supplier, via a communication network such as a phone line.

The present patent application is based on Japanese Patent Application (Application No. 2008-132129) filed on May 20, 2008 in Japan, the entire contents of which is incorporated herein by reference.

### INDUSTRIAL APPLICABILITY

As described above, the appliance monitoring apparatus of the present invention can report an amount of CO₂ emission of each appliance. Therefore, it is useful for enlightening the user on an environmental consciousness.

1. An appliance monitoring apparatus comprising:
a flow detection unit disposed in a gas flow path in a gas meter and configured to detect a gas flow;
an appliance determination unit configured to determine a gas appliance used by a client by leaning a flow value used by the client and a gas consumption time in accordance with a signal from the gas flow detection unit, and to output a gas flow signal used by the gas appliance;
a CO₂ emission data storage unit configured to store an amount of a CO₂ emission previously determined for each type of the gas appliance as database; and
a CO₂ emission calculation unit configured to compute, integrate, and store an amount of CO₂ emission based on the CO₂ emission data pertaining to a gas appliance selected from the CO₂ emission data storage unit on receipt of a signal from the appliance determination unit, a gas flow of the selected gas appliance, and a gas consumption time of the selected gas appliance.

2. The appliance monitoring apparatus according to claim 1, wherein the CO₂ emission data storage unit is configured such that the database of CO₂ emission previously stored for each type of the gas appliance is changeable from an outside.

3. The appliance monitoring apparatus according to claim 1, wherein when the integrated and stored amount of CO₂ emission has exceeded a value of a preset amount of CO₂ emission, the CO₂ emission calculation unit outputs that effect to an outside.

4. The appliance monitoring apparatus according to claim 1, wherein every time the integrated and stored amount of CO₂ emission has exceeded a plurality of values of preset amounts of CO₂ emissions, the CO₂ emission calculation unit outputs that effect to an outside.

5. The appliance monitoring apparatus according to claim 1, wherein information about the integrated and stored amount of CO₂ emission is displayed.

6. The appliance monitoring apparatus according to claim 1, wherein information about the integrated and stored amount of CO₂ emission is output to an outside.
